(19) United States
(12) Patent Application Publication
(10) Pub. No.: US 2016/0190529 A1
(43) Pub. Date: Jun. 30, 2016

(54) Waterproof Removable Battery

(71) Applicant: Xing Du, Newport Beach, CA (US)

(72) Inventor: Xing Du, Newport Beach, CA (US)

(21) Appl. No.: 14/587,146

(22) Filed: Dec. 31, 2014

(51) Int. Cl. H01M 2/10

(52) U.S. Cl. CPC H01M 2/1094; H01M 2/1022; H01M 2220/30

(57) ABSTRACT

This invention relates generally to waterproofing of a removable battery configured to prevent seeping of water into the battery component through the use of a rubber frame.

### FIELD OF THE INVENTION

The present invention generally relates to removable batteries and in particular to waterproofing of batteries for electronic devices such as cellular phones, cameras, and players.

### BACKGROUND OF THE INVENTION

Removable batteries are commonly employed to power electronic devices. In contrast to permanently embedded batteries, removable batteries are more likely to sustain damage, and thereby disabling use of the electronic device. Specifically, at an area of a battery housing where a removable battery may be detached from or where there is a door that provides access to a battery compartment, such areas remain pervious to external agents, such as water, that may cause damage to the electronic device or the removable battery itself. For instance, when external agents enter the electronic device through these points of access, they may damage and corrode sensitive components of the battery or the electronic device, such as contact terminals, SIM card slots and/or memory card slots.

Removable batteries have facilitated the use of numerous types of electronic devices. Specifically, removable batteries have contributed to the portability of such electronic device. However, since removable batteries are not permanently embedded within the electronic device, the battery housings of removable batteries or the components of an electronic device that secure a removable battery to the electronic device become susceptible to potentially damaging external agents, such as water. These environmental agents are able to enter into areas with sensitive electronic components via the seams of battery housings or gaps between a removable battery and securing components of the electronic device. Therefore, greater caution is required where there is an enhanced threat of environmental exposure and damage.

Water damage (or similar damage caused by other liquids) is one of the most undesirable problems that can affect an electronic device. Water that enters a device, for example through the removable battery compartment into the battery housing, can lead to numerous problems. In the short term water damage can cause short-circuiting of the electronic device. In the long term, water damage can corrode the internal metal parts of the electronic device. Accordingly, there is a need in the arts for a way to prevent water to permeate into an electronic device and allow for use of an electronic device in a wet or aqueous environment while simultaneously keeping the battery design streamlined.

Therefore, there is a need in the art for a removable battery usable with external devices and impermeable to external environmental agents such that the electronic device may continue to function properly, even when exposed to such external environmental agents. This and other features and advantages of the present invention will be explained and will become obvious to one skilled in the art through the summary of the invention that follows.

### SUMMARY OF THE INVENTION

Accordingly, embodiments of the present invention are directed to a battery seal comprising a frame comprising of a water-proof material and a compressible body having an inner surface and an outer surface, wherein the frame is configured to be affixed at the inner surface along a perimeter of a least one battery wall containing one or more of a battery terminal, which is designed to mate with one or more corresponding parts within a battery housing of an electronic device, and wherein the battery seal is configured to engage with a battery housing at the outer surface of the rubber frame such that the rubber frame plugs a junction between the battery wall and the battery housing.

According to embodiments of the present invention, the frame is comprised of two or more of a water-proof material.

According to embodiments of the present invention, the frame is configured to be fixed along a perimeter of at least one battery wall.

According to embodiments of the present invention, the frame is configured to be fixed along a perimeter of at least one battery wall that comprises one or more of a battery connector.

According to embodiments of the present invention, a frame is configured to be fixed along the perimeter of at least one battery wall housing one or more of an insertion slot for one or more of a memory chip.

An embodiment of the present invention is directed to a waterproof removable battery configured to prevent water permeation into a battery housing of an electronic device, comprising of a removable battery which has a top end, a bottom end, at least one battery wall, and one or more battery terminals, wherein said one or more battery terminals are configured to mate with one or more corresponding parts in a battery housing; a frame fixed along a perimeter of each of the battery walls containing at least one of said one or more battery terminals, wherein the frame is configured to engage with the battery housing such that the frame forms a watertight seal at a junction between the battery and the battery housing when the battery is inserted into the battery housing of the electronic device.

According to embodiments of the present invention, the frame of the waterproof removable battery is constructed from one or more water-proof materials.

According to embodiments of the present invention, the frame of the waterproof removable battery further surrounds an insertion slot for one or more of memory chips.

According to embodiments of the present invention, the frame of the waterproof removable battery further surrounds one or more battery connectors.

According to embodiments of the present invention, the frame of the waterproof removable battery is continuous and surrounds a circumference along one or more battery walls.

According to embodiments of the present invention, the frame of the waterproof removable battery further surrounds one or more of an interfacing surface.

According to embodiments of the present invention, the frame of the waterproof removable battery further surrounds one or more of an interaction component.

### BRIEF DESCRIPTION OF THE DRAWINGS

FIG. 1 is a perspective view of a battery seal in accordance with an embodiment of the present invention.

FIG. 2 is a perspective view of a waterproof removable battery in accordance with an embodiment of the present invention.

FIG. 3 is a perspective view of a waterproof removable battery in accordance with an embodiment of the present invention.

FIG. 4 is a perspective view of a waterproof removable battery in accordance with an embodiment of the present invention.

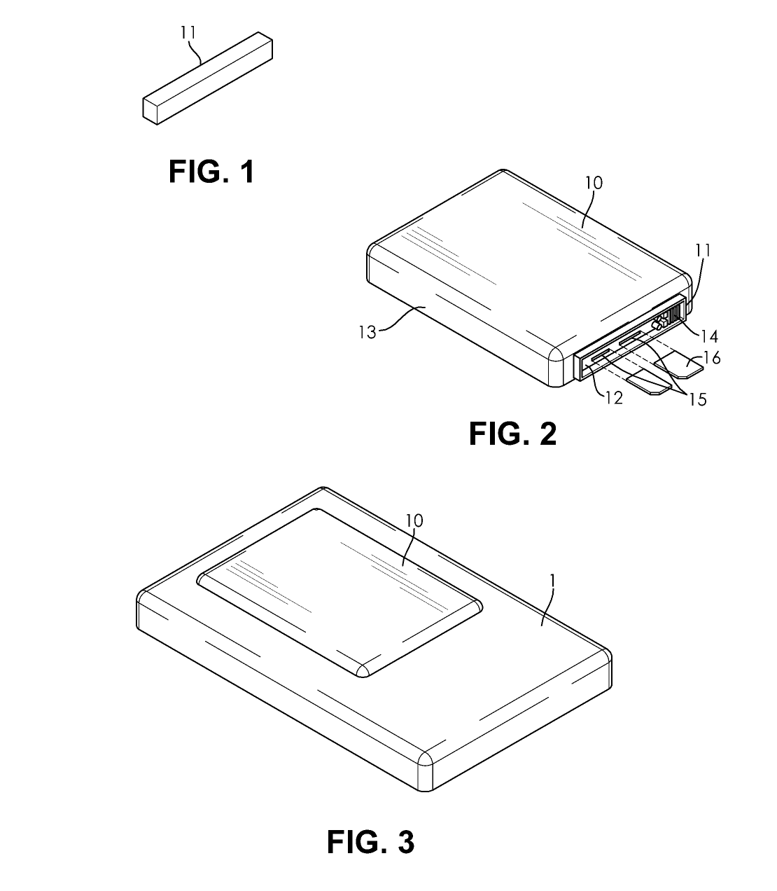

### DETAILED SPECIFICATION

Embodiments of the present disclosure are now described in detail with reference to the accompanying drawings.

According to an embodiment of the present invention, a battery seal consists of a frame of waterproof material. In an embodiment of the current invention, the frame is composed of a rubber material. Other examples include silicone-based material such as siloxane, silane and silicone rubber. In other embodiments, a combination of waterproof materials can be used to construct the frame. One of ordinary skill in the art would appreciate that there are numerous types of waterproof materials that could be utilized, and embodiments of the present invention are contemplated for use with any appropriate waterproof material.

In addition to the composition of the waterproof material, such material must also be compressible. In order to form a seal that prevents seeping of water between the battery and the battery housing, the frame must have the ability to be forced into less space. Such adaptability into smaller space fills any gap that may result from the mating of the battery to the battery housing.

In certain embodiments of the claimed invention, the frame is fixed along a wall of battery. Accordingly, the frame can be adapted to conform to a variety of shapes and sizes depending on the shape of the battery wall and the portion of the electronic device the battery wall will contact with. In the case where the battery is cuboid (or similar to a cuboid but with rounded edges), the wall of the battery is square in nature. Therefore, the frame is configured to be a square structure. In the case where the battery is cylindrical, the battery wall may be circular, in which case the frame is also circular.

In other embodiments, the frame may be shaped differently than the shape of the battery. For instance, on a cuboid battery, a frame could be circular. In these embodiments, the important factor of the shape of the frame is that the frame is capable of creating a seal between the battery and electronic device such that the sensitive electrical contacts and other sensitive components (e.g., SIM card slot, memory card slot) are protected from external environmental agents.

In embodiments of the current invention, the frame is affixed to a wall comprising a battery terminal. The battery terminal is any component of the battery that makes an electrical contact with the electronic device. As an example, a cylindrical dry battery has two battery terminals: a protruding positive terminal on one end and a flat negative terminal on the other end. The positive terminal of a dry battery makes an electrical contact with one or more electrically conductive (e.g., metal) strips in the battery housing of an electronic device while the negative terminal mates with springs in the battery housing. Since the electrical contact between a battery terminal and the housing is necessary for the operation of the electronic device, embodiments of the present invention are designed to be affixed along the wall comprising such battery terminal.

The type of terminal does not limit the functionality of embodiments of the present invention. As examples, a battery terminal can consist of coil springs, as found in six-volt lantern batteries or as flat bases as may exist on the batteries of cellular phones.

The battery may also include other functional components that interact with non-battery parts. For example, the battery may include one or more functional components required for wireless charging. Alternatively, the battery terminal may also include one or more functional components for Near Field Communication (NFC) or other forms of communications (e.g., WIFI, CDMA, GSM).

According to an embodiment of the present invention, the frame may be affixed to the battery by one or more affixing means. In preferred embodiments of the present invention, affixing means may include, but are not limited to, drying adhesives such as white glue, contact adhesives, and rubber cement. Other embodiments utilize hot adhesives such as styrene block copolymers (SBC). One of ordinary skill in the art would appreciate that there are numerous types of affixing means that could be utilized, and embodiments of the present invention are contemplated for use with any appropriate affixing means.

In general, a battery housing is one or more of a chamber that holds a battery within an electronic device. Components of the battery housing must make at least some electrical contact with components of the battery (typically the battery terminal) in order to allow for the operation of the electronic device.

In embodiments of the claimed invention, the battery seal does not interfere with the function of the battery in operating the electronic device. The claimed invention is intended to plug any resulting crevice or junction when a removable battery is inserted into its corresponding battery housing within the electronic device. Accordingly, the claimed invention is designed such that the frame of the battery seal does not interfere with any mating components between the battery and the battery housing.

Multiple types of batteries are envisioned to be affixed with the claimed invention to render the electronic device housing the battery impermeable to water. Such batteries may have additional functional components that may require protection against water damage. Accordingly, embodiments of the current invention include a frame affixed around or otherwise beyond such functional components of the battery such as to provide protection for the functional components as well as the terminals of the battery. Functional components include one or more of insertion slots for one or more of memory chips. Such functional components are typical of a cellular phone battery. For example, cellular phone batteries may include insertion slots for memory cards and/or Subscriber Identity Module (SIM) cards along the wall of a battery.

In certain embodiments, the battery may connect to an electronic device, where the electronic device has functional components in or around the same area where the battery connects to the electronic device. For instance, the battery compartment of an electronic device may also house slots for memory cards and/or SIM cards. In these embodiments, the frame may be affixed to the battery such that the functional components of the electronic device, as well as the electrical terminals, are protected by the seal formed when the frame engages between the battery and the electronic device.

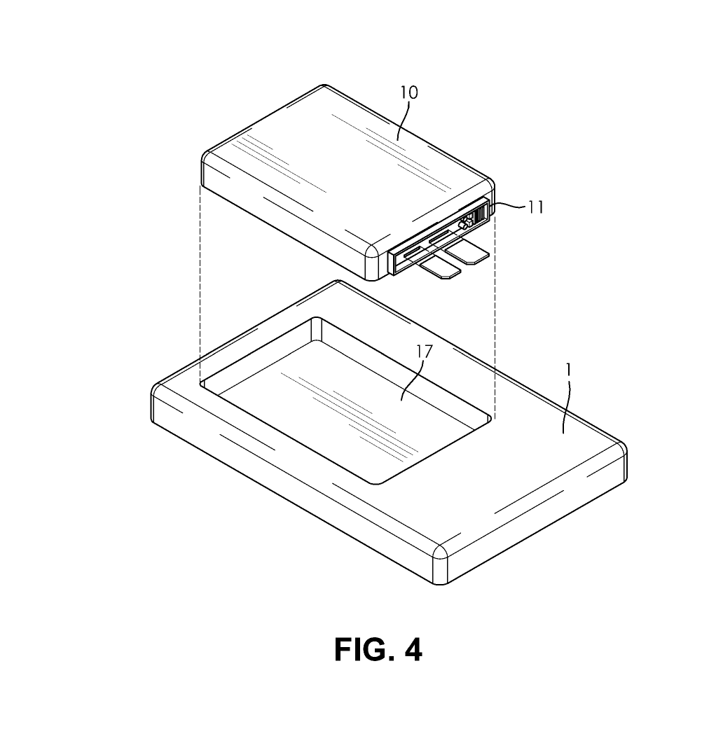

FIG. 2, FIG. 3 and FIG. 4, display a waterproof removable battery (10) configured to prevent water permeation into a battery housing (17) of an electronic device (1). The battery comprises a removable battery with a top end, a bottom end, at least one battery wall (13), one or more battery terminals (12) to mate with corresponding parts in the battery housing (17), and a frame (11) affixed along the perimeter of at least one battery wall (13) containing the battery terminal (12). The frame (10 engages with the battery housing (17) such that the frame (11) seals a junction between the battery (10) and the battery housing (17) when the battery (10) is inserted into the battery housing (17) of an electronic device (1).

In the current embodiment, the frame (11) espouses a rectangular shape. The frame can be adapted into any shape or size depending on the configuration of the wall comprising the battery terminal (12).

In an embodiment of the current invention, in the case where the battery has multiple battery terminals at different walls, each battery terminal (12) is surrounded by a frame (11) at each wall (13).

In addition to battery terminals, there may be additional interfacing battery surfaces that require protection from water damage. Accordingly, in embodiments of the current invention, a frame surrounds such interfacing battery surface. The interfacing surface is a battery wall that contains functional parts of the battery that have at least one interactive component that interacts with at least one non-battery part. These interactions may be physical or non-physical (e.g. electrical, digital, magnetic, electromagnetic, or thorough radio waves, etc). In other embodiments of the current invention, a frame surrounds one or more interaction components rather than the entire surface.

Types of interaction components include connectors (14) required to properly configure a battery within a battery housing or connectors serving to provide appropriate electrical connections for functioning of the battery. As an example specific to cell phones, battery connector pinouts include a thermistor, which monitors internal temperature during charging. Accordingly, in an embodiment of the current invention, a waterproof removable battery (10) is surrounded with a frame (11) along the perimeter of a battery wall that contains connectors (14).

In an embodiment of the current invention, a battery will have one or more components for wireless charging. For example, the wireless charging component may include one or more of an induction coil to receive or transmit an alternating electromagnetic field. In other embodiments of the current invention, a frame surrounds a wireless charging component for wireless charging rather than an entire surface containing the components for wireless charging.

In an embodiment of the current invention, an interfacing battery surface will have one or more of an communication components for wireless communications (e.g., NFC). For example, the communication components may include one or more of an antenna employed for NFC, an antenna employed for WIFI signals, an antenna employed for cellular signals (e.g., GSM, CDMA). In other embodiments of the current invention, a frame surrounds a communications component rather than the entire surface containing the communication components.

In embodiments of the invention, a battery may have multiple frames: one at a wall having a terminal and another frame at a wall having an interfacing surface and/or one or more of a functional component (e.g., wireless charging component, communications component). Alternatively, embodiments of the current invention require only a single frame if a terminal and a functional component are located at the same wall.

In an embodiment of the current invention, an additional frame (11) surrounds the wall containing insertion slots for one or more memory chips (15). Such memory chips include a subscriber identification module (SIM) card and a memory card (16). In an exemplary embodiment, a single frame (11) collectively borders a battery terminal (12) and insertion slots (15) for one or more memory chips (16).

In an embodiment of the current invention, a waterproof removable battery (10) is surrounded by a frame (11) at each wall of the battery. This embodiment seals any gap or crevice that is formed by the insertion of a removable battery within a battery housing of an electronic device.

Instead of having multiple frames at multiple walls surrounding necessary electronic components, the frame can be configured such that a frame wraps the circumference or perimeter of the battery itself at the top end. In this embodiment,

The manners in which the waterproof replaceable battery is removed or inserted are disclosed. As displayed in FIG. 4, the current invention may be removed by lifting the battery out of the battery component while current invention may be inserted by pushing the waterproof replaceable battery into the battery compartment. Alternatively, the battery may be removed and inserted by sliding the battery out of or into the battery housing.

While preferred embodiments of the present invention described above have focused on watertight seals being formed between a battery and an electronic device via a seal formed there between, one of ordinary skill in the art would appreciate that other types of seals could be formed as well. For instance, hermetic seals could be formed, where the components to be protected from exposure to air or other particulate that would surpass a watertight seal. Further embodiments may not have a seal that is watertight, such as seals that are merely adapted to prevent larger particulate (e.g., dirt, debris) from entering into the battery compartment. These seals are contemplated for use with embodiments of the present invention.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A battery seal comprising:
a frame comprising a water-proof material and a compressible body having an inner surface and an outer surface,
wherein the frame is configured to be affixed at the inner surface along a perimeter of at least one battery wall containing one or more of a battery terminal, which is designed to mate with one or more corresponding parts within a battery housing of an electronic device, and
wherein the battery seal is configured to engage with a battery housing at the outer surface of the rubber frame such that the rubber frame plugs a junction between the battery wall and the battery housing.

2. The frame of claim 1 comprising of two or more of a water-proof material.

3. The frame of claim 1, configured to be fixed along a perimeter of at least one battery wall.

4. The frame of claim 1, configured to be fixed along a perimeter of at least one battery wall comprising one or more of a battery connector.

5. The frame of claim 1, configured to be fixed along a perimeter of at least one battery wall comprising of one more of an insertion slot for one or more of a memory chip.

6. A waterproof removable battery configured to prevent water permeation into a battery housing of an electronic device, comprising:
a removable battery with a top end, a bottom end, at least one battery wall, and one or more battery terminals,
wherein said one or more battery terminals are configured to mate with one or more corresponding parts in a battery housing;
a frame fixed along a perimeter of each of the battery walls containing at least one of said one or more battery terminals,
wherein the frame is configured to engage with the battery housing such that the frame forms a watertight seal at a junction between the battery and the battery housing when the battery is inserted into the battery housing of the electronic device.

7. The waterproof removable battery of claim 6, wherein the frame is constructed from one or more water-proof materials.

8. The waterproof removable battery of claim 6, wherein the frame further surrounds an insertion slot for one or more memory chips.

9. The waterproof removable battery of claim 6, wherein the frame further surrounds one or more battery connectors.

10. The waterproof removable battery of claim 6, wherein the frame is continuous and surrounds a circumference along one or more battery walls.

11. The waterproof removable battery of claim 6, wherein the frame further surrounds one or more of an interfacing surface.

12. The waterproof removable battery of claim 6, wherein the frame further surrounds one or more functional components.
